(19) United States
(12) Patent Application Publication
(10) Pub. No.: US 2019/0336893 A1
(43) Pub. Date: Nov. 7, 2019

(54) FILTER TRAY WITH REMOVABLE FILTER MEDIA

(71) Applicant: PITCO FRIALATOR, INC., Bow, NH (US)

(72) Inventors: Michael McGinnis, Windham, NH (US); Steven Savage, Concord, NH (US); Steven J. Cyr, Londonderry, NH (US); Steven Gallerani, Northwood, NH (US); Karl M. Searl, Newmarket, NH (US)

(73) Assignee: PITCO FRIALATOR, INC., Bow, NH (US)

(21) Appl. No.: 15/970,465

(22) Filed: May 3, 2018

(51) Int. Cl. B01D 29/96; A47J 37/12; B01D 29/05

(52) U.S. Cl. CPC B01D 29/96; B01D 2201/40; B01D 29/05; A47J 37/1223

(57) ABSTRACT

The present disclosure provides a filter tray and filter tray assembly with removable filter media. The filter tray may include a quick-release retainer or spring-clip pivotally engaged with the tray and engageable with the tray to form a pressure fit over a filter medium. The filter tray may further include or interface to a handle extension and/or a removeable handle for manipulation of the filter tray, including removing and replacing the filter tray in a deep fryer cooking system.

### FIELD

The present disclosure relates to a filter tray, and more particularly to a filter tray for holding removable filter media.

### BACKGROUND

Deep frying systems, and other liquid fat-based cooking systems require filtering of cooking liquid, such as oil, to remove debris and other polar materials from the liquid to preserve the quality and life-span of the cooking liquid. In an oil-based deep fryer system in which food items are submerged in the cooking oil, crumbs and other food-borne particles may separate from the food items, leaving the cooking oil degraded. Complex filtration systems are traditionally implemented to remove the oil from the cooking vat or frypot of the system, pass the oil through a filtering process and return the recycled oil to the frypot. Such filtration systems are often located below or behind the system making the required maintenance and servicing difficult and time consuming.

### SUMMARY

The present disclosure provides a convenient and user-friendly removable filter tray for use with removable filtering media in a liquid-fat-based cooking system. The filter tray may receive removable filtering media that may be easily discarded and replaced on a regular basis.

According to one embodiment of the present disclosure a filter tray is presented. The filter tray may include a tray having a bottom surface and in internal perimeter. The tray may further include a spring-clip retaining a shape substantially similar to the internal perimeter. The spring-clip may be pivotally engaged with the tray and further include a latch that is securable to the tray. The tray may also include a handle extension affixed to the at least one side wall.

According to another embodiment of the present disclosure, a filter tray is presented that may include a tray having at least one wall and a bottom surface. A retainer may be pivotally attached to the at least one wall and further include a latch. The latch may be configured to engage a recess in a wall of the tray to secure the retainer to the bottom surface of the tray and thereby secure the removable filter media in the tray. The filter tray may also include a handle extension affixed to the tray.

### BRIEF DESCRIPTION OF THE DRAWINGS

Embodiments of devices, systems, and methods are illustrated in the figures of the accompanying drawings, which are meant to be exemplary and non-limiting, in which like references are intended to refer to like or corresponding parts, and in which:

FIG. 1 is a perspective view of a filter tray in an open position according to one embodiment of the disclosure;

FIG. 2 is a perspective view of a filter tray and a filter medium according to one embodiment of the disclosure;

FIG. 3 is a perspective view of a filter tray in a closed position according to one embodiment of the disclosure;

FIGS. 4A-4B are perspective views of a filter tray assembly according to one embodiment of the disclosure; and

FIG. 5 is a partially sectioned view of a removable handle according to the disclosure.

### DETAILED DESCRIPTION

Embodiments of the present disclosure include a filter tray and filter tray assembly with removable filter media. The filter tray may include a quick-release or other easily releasable retainer or spring-clip pivotally engaged with the tray and engageable with the tray to form a pressure fit over a filter medium. The filter tray may further include a handle extension for manipulation of the filter tray, including removing and replacing the filter tray in a deep fryer cooking system.

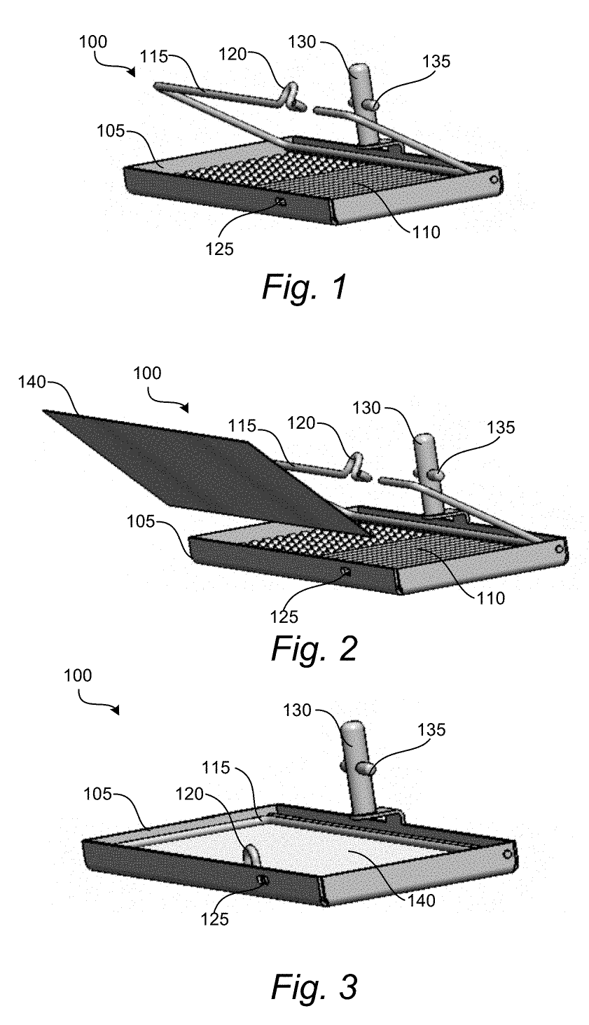

FIG. 1 is a perspective view of a filter tray 100 in an open position according to one embodiment of the disclosure. The filter tray 100 may include a tray 105 having or forming a bottom surface 110. The tray 105 may include one or more side walls defining an internal perimeter. The tray 105 may be rectangular in shape or may be circular, oval or polygonal. The bottom surface 110 may be grated, porous, or otherwise liquid-permeable to allow the flow-through of a cooking oil or other liquid fat. The tray 105 and bottom surface 110 may be made or formed from a perforated sheet, a wire weave, wire grate made from a metal or other alloy, such as steel, or another sturdy material that may withstand high temperature liquids without deformation or degradation.

A retainer such as a spring-clip 115 may be pivotally attached to the tray 105. The spring-clip 115 may be sized and shaped to substantially match the internal perimeter of the tray 105. As shown, the spring-clip 115 may be a substantially rigid structure sized and shaped to be slightly smaller than the perimeter of the tray in order to fit within the tray. The spring-clip 115 may be shapes other than rectangular, and sized/shaped to substantially match the internal perimeter of the tray. The spring-clip could be any of various shapes, for example, a criss-cross (across the tray), geometric shapes (within the tray), or even alphanumeric shapes.

The spring-clip 115 may be made or formed from a stiff material such as a metal alloy or other heat-resistant material. The materials used and the shape formed for the spring-clip 115 may be chosen to accommodate the limited malleability and flexibility required, yet maintain its heat resistance and strength. The spring-clip 115 may include a latch 120 configured to engage the tray 105 when the spring-clip is in a closed position. The latch may include a quick-release mechanism to allow a faster and easy release of the spring-clip 115 from its engagement with the tray 105. The latch 120 may be configured to accommodate a one-handed release using a pinching or squeezing movement of the latch 120.

The substantial rigidity of the spring-clip 115 may allow a slight flexibility in the spring-clip 115 to manipulate the latch 120 into a secure engagement with the tray 105. The spring-clip 115 may also be sized and shaped such that, when the latch 120 of the spring-clip 115 is engaged with the tray 105 the spring-clip 115 rests securely over the bottom surface 110 and around the internal perimeter of the tray 105. To secure the spring-clip 115, the latch 120 may engage with a receiver 125, such as a recess, hole or other mechanism configured to receive and secure the latch 120.

A handle extension 130 may be attached to the tray 105. The handle extension 130 may serve as a handle itself or may serve as an attachment point for a removeable handle, as discussed below. The handle extension 130 may include one or more projections 135 to facilitate grasping the filter tray or attaching a removable handle.

FIG. 2 is a perspective view of a filter tray 100 and a filter medium 140 according to one embodiment of the disclosure. The filter medium 140 may include a filter paper or other porous material that allows the flow-through of cooking fluid but impedes any solid particles. The filter medium 140 may be sized and shaped to cover the bottom surface 110. That is the filter medium 140 may substantially match the size and shape of the bottom surface 110 of the tray or be just-larger than the surface area of the bottom surface 110. In operation, the filter medium 140 may be inserted into the tray 105, below the spring-clip 115, and over the bottom surface 110. With the filter medium 140 in place the spring-clip 115 may be lowered with the perimeter of the filter medium 140 tucked securely beneath the spring-clip 115, and the catch 120 may be engaged with the receiver 125.

FIG. 3 is a perspective view of a filter tray 100 in a closed position according to one embodiment of the disclosure. With the filter medium 140 in place, the spring-clip 115 lowered, and the catch 120 engaged with the receiver 125, the spring-clip 115 may form a secure and pressing engagement with the filter medium 140 against the bottom surface 110 of the tray. The filter tray 100, with the filter medium 140 secured in place, may be installed or placed in a location within the frypot suitable for catching and collecting solid debris from cooking oil passing through the filter media and bottom surface 110. For example, the filter tray may be installed over a drain, or at a lowest point in a portion of the frypot. Draining oil may pass through the filter tray and filter medium, or falling debris sinking through the oil by gravity, may result in solid particles trapped in the filter medium 140.

When the filter medium 140 becomes saturated with solid debris, or during routine scheduled maintenance, the filter tray 100 may be removed from the frypot by use of the handle extension 130, or removable handle 145. The handle extension 130 and/or removable handle 145 enable lifting of the filter tray upwards from where it is positioned within a portion of the frypot.

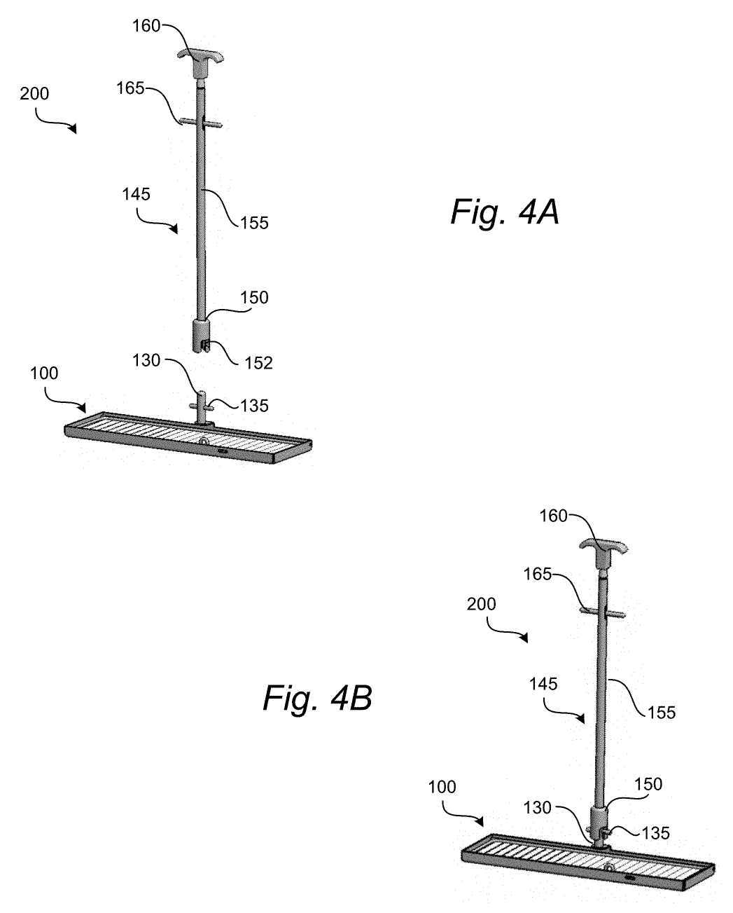

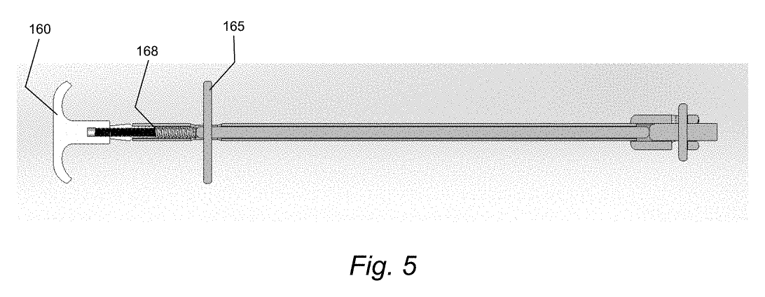

FIGS. 4A-4B are perspective views of a filter tray assembly 200 according to one embodiment of the disclosure. FIG. 4A depicts the filter tray assembly 200 prior to attachment of a removable handle 145. FIG. 4B depicts the filter tray assembly 200 with the removable handle attached to the filter tray 100. The removable handle 145 may include a collar 150 disposed on a distal end of the removable handle 145. The removable handle and its components described herein may be made or formed from a metal alloy, such as steel, or another sturdy and heat resistant material. The collar 150 may include or define one or more grooves 152, or other sized recesses to accommodate the projections 135 of the handle extension 130. The grooves 152 may be shaped to accommodate a slip lock, luer-like lock, or other twist lock or fit engagement with the handle extension.

The removable handle 145 may further include a body 155 extending from the distal end and the collar 150 to a proximate end where a hand-grasp 160 is affixed. The hand-grasp 160 may be shaped and sized to accommodate one-handed grip and operation. The hand-grasp 160 may be made or formed from a non-conductive and non-heat retaining material such as a plastic or other polymer. The hand-grasp 160 may be affixed to the body 155 of the removable handle 145 by welding or using an adhesive, fasteners, screw attachment, or the like.

The removable handle 145 may further include one or more flanges 165 extending from the body 155. The flanges 165 create a handle assembly that, along with the hand-grasp 160, act as a grip to release and engage a spring loaded pin 168 that runs through the center of the handle assembly. When the handle is in place on the filter pan, the operator will need to pull back on the “T” (165), then push the handle in place and turn. The pin will hold the engagement of the handle in, locked place when the T (165) is released. The flanges 165 may also be used to hang the removable handle, such as on a wall or in a holder, when not in use or provide additional support to an operator during use.

The arrangement and configuration of the collar 150 and handle extension 130 provide an ergonomic and quick mechanism for placing and removing the filter tray 100 from the frypot without requiring an operator to contact the potentially heated metal of the filter tray 100 or come in contact with heated oil in the frypot or in the filter tray 100.

While embodiments of the present disclosure describe a substantially rectangular tray with one or more side walls defining an internal perimeter, one of ordinary skill in the art will recognize that the shape of the filter tray 100 is not so limited and other shaped may be implemented, such as circular, oval, or polygonal, without deviating from the scope of the invention.

While the embodiments of the present disclosure describe the retainer as a pivoting spring-clip, one of ordinary skill in the art will recognize that other retainer mechanisms, such as a friction fit spring, a clamp, or the like, may be implemented without deviating from the scope of the invention.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” “substantially,” or the like, when accompanying a numerical value or direction are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the description and following claims, it is understood that terms such as “first,” “second,” “third,” “above,” “below,” and the like, are words of convenience and are not to be construed as limiting terms unless expressly stated otherwise.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the disclosure as defined by the following claims, which are to be interpreted in the broadest sense allowable by law.

What is claimed is:

1. A filter tray comprising:
a tray having a bottom surface and in internal perimeter;
a spring-clip retaining a shape substantially similar to the internal perimeter, the spring-clip pivotally engaged with the tray to retain filter medium within the tray, the spring-clip further including a latch securable to the tray to hold the latch and spring-clip in engagement with the tray.

2. The filter tray of claim 1 further comprising a filter medium shaped substantially similar to the bottom surface, the filter medium secured to the filter tray by engagement of the latch with the tray.

3. The filter tray of claim 2 wherein the filter medium has a surface area just-larger than the bottom surface of the tray.

4. The filter tray of claim 1 wherein the tray further comprises at least one wall, the spring-clip pivotally engaged with the at least one wall.

5. The filter tray of claim 4 wherein the side wall defines a recess for receiving the latch of the spring-clip.

6. The filter tray of claim 1 wherein the bottom surface is porous.

7. The filter tray of claim 1 wherein the bottom surface is grated.

8. The filter tray of claim 1 further comprising a handle extension affixed to the tray configured to receive a removable handle, the removable handle securable to the handle extension.

9. The filter tray of claim 8 wherein the handle extension comprises at least one projection, the at least one projection engaging the removable handle.

10. The filter tray of claim 9 wherein the removable handle comprises a collar on a distal end and a hand-grasp on a proximate end, the collar further defining at least one groove for engaging the at least one projection.

11. The filter tray of claim 10 wherein the collar engages the at least one projection of the handle extension in a twist lock engagement.

12. The filter tray of claim 1 wherein the tray is substantially rectangular.

13. The filter tray of claim 1 wherein the tray is substantially circular.

14. A filter tray comprising:
a tray having at least one wall and a bottom surface;
a retainer pivotally attached to the at least one wall, the retainer further including a latch, the latch configured to secure the retainer to the bottom surface of the tray; and
a handle extension affixed to the tray.

15. The filter tray of claim 14 wherein the bottom surface is grated.

16. The filter tray of claim 14 further comprising a filter medium sized and shaped to cover the bottom surface of the tray; the filter medium securable to the bottom surface of the tray by engagement of the latch.

17. The filter tray of claim 16 wherein the filter medium is porous.

18. The filter tray of claim 16 wherein the filter medium is a paper filter.

19. The filter tray of claim 16 wherein the at least one wall defines a recess sized and shaped to receive the latch, the retainer forming a pressure fit over the filter medium against the bottom surface of the tray.

20. The filter tray of claim 14 wherein the retainer is a substantially rigid spring-clip.
